(19) United States
(12) Patent Application Publication
(10) Pub. No.: US 2025/0217133 A1
(43) Pub. Date: Jul. 3, 2025

(54) MAINTAINING SYNCHRONIZATION OF CODE FOR A PRODUCTION ENVIRONMENT

(71) Applicant: Capital One Services, LLC, McLean, VA (US)

(72) Inventors: Mahendher GOVINDASINGH KRISHNASINGH, Brambleton, VA (US); Maksym BEZKOROVAINYI, Ashburn, VA (US); Vishal GUPTA, Chantilly, VA (US); Jonathan RODRIGUEZ, Brambleton, VA (US)

(21) Appl. No.: 18/399,003

(22) Filed: Dec. 28, 2023

(51) Int. Cl. G06F 8/71

(52) U.S. Cl. CPC G06F 8/71

(57) ABSTRACT

In some implementations, a device may receive a request to deploy a codebase of a code repository in a production environment. The request may indicate a first version identifier associated with the codebase and a second version identifier associated with a previous codebase that is updated by the codebase. The device may retrieve, from an entry associated with the code repository in a data structure, a third version identifier associated with a current codebase most-recently successfully deployed in the production environment. The device may compare the second version identifier with the third version identifier. The second version identifier matching the third version identifier may indicate that the previous codebase is the current codebase most-recently successfully deployed in the production environment. The device may cause, responsive to the second version identifier matching the third version identifier, deployment of the codebase in the production environment.

### BACKGROUND

Software development projects may be completed by distributed teams of dozens, hundreds, or even thousands of developers. Each team may perform development activities, such as coding, quality control checking, code deployment, or the like. Each software development project may include numerous code files that are modified frequently.

### SUMMARY

Some implementations described herein relate to a system for maintaining synchronization of code for a production environment. The system may include one or more memories and one or more processors communicatively coupled to the one or more memories. The one or more processors may be configured to receive, from a deployment system, a request to deploy a codebase of a code repository in a production environment, where the request indicates a first version identifier associated with the codebase and a second version identifier associated with a previous codebase that is updated by the codebase. The one or more processors may be configured to retrieve, responsive to the request and from an entry associated with the code repository in a data structure, a third version identifier associated with a current codebase most-recently successfully deployed in the production environment. The one or more processors may be configured to compare the second version identifier with the third version identifier, where the second version identifier matching the third version identifier indicates that the previous codebase is the current codebase most-recently successfully deployed in the production environment. The one or more processors may be configured to selectively cause, responsive to whether the second version identifier matches the third version identifier, deployment of the codebase in the production environment by the deployment system.

Some implementations described herein relate to a method of maintaining synchronization of code for a production environment. The method may include receiving a request to deploy a codebase of a code repository in a production environment, where the request indicates a first version identifier associated with the codebase and a second version identifier associated with a previous codebase that is updated by the codebase. The method may include retrieving, from an entry associated with the code repository in a data structure, a third version identifier associated with a current codebase most-recently successfully deployed in the production environment. The method may include comparing the second version identifier with the third version identifier, where the second version identifier matching the third version identifier indicates that the previous codebase is the current codebase most-recently successfully deployed in the production environment. The method may include causing, responsive to the second version identifier matching the third version identifier, deployment of the codebase in the production environment.

Some implementations described herein relate to a non-transitory computer-readable medium that stores a set of instructions for maintaining synchronization of code for a production environment. The set of instructions, when executed by one or more processors of a device, may cause the device to receive, from a deployment system, a request to deploy a codebase of a code repository in a production environment, where the request indicates a first commit hash associated with the codebase and a second commit hash associated with a previous codebase that is updated by the codebase. The set of instructions, when executed by one or more processors of the device, may cause the device to retrieve, responsive to the request and from a data structure, a third commit hash associated with a current codebase most-recently successfully deployed in the production environment. The set of instructions, when executed by one or more processors of the device, may cause the device to compare the second commit hash with the third commit hash, where the second commit hash matching the third commit hash indicates that the previous codebase is the current codebase most-recently successfully deployed in the production environment. The set of instructions, when executed by one or more processors of the device, may cause the device to cause, responsive to the second commit hash matching the third commit hash, deployment of the codebase in the production environment.

### BRIEF DESCRIPTION OF THE DRAWINGS

FIGS. 1A-1D are diagrams of an example associated with maintaining synchronization of code for a production environment, in accordance with some embodiments of the present disclosure.

FIG. 2 is a flowchart of an example process associated with maintaining synchronization of code for a production environment, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with maintaining synchronization of code for a production environment, in accordance with some embodiments of the present disclosure.

FIG. 5 is a flowchart of an example process associated with maintaining synchronization of code for a production environment, in accordance with some embodiments of the present disclosure.

### DETAILED DESCRIPTION

The following detailed description of example implementations refers to the accompanying drawings. The same reference numbers in different drawings may identify the same or similar elements.

In a version control system, changes to code may be stored in a series of snapshots called commits. Each commit may include a unique identifier, a timestamp, and/or a description of the changes made, among other examples. Developers can create branches in a code repository, which allow them to work on separate versions of the code without affecting a main branch. Once changes have been made, the changes can be merged back into the main branch.

A particular codebase may be deployed in a production environment, and various developers may be working on separate branches based on the codebase in connection with new features, bug fixes, security updates, or the like. The codebase deployed in the production environment may be updated from time to time with new codebases as work on these branches is completed. Once a new codebase is deployed in the production environment, a branch based on a codebase previously deployed in the production environment may become outdated (e.g., the previous codebase may lack features, bug fixes, security updates, or the like, of the new codebase). However, the outdated nature of the branch may be unknown, and/or the branch may already be scheduled for deployment or in the process of being deployed. Accordingly, if a codebase of the outdated branch were to be deployed in the production environment, critical features, bug fixes, security updates, or the like, can be lost. This may expose systems implementing the production environment to inefficiencies (e.g., which may result in the consumption of excessing processor resources, memory resources, and/or network resources) and/or vulnerabilities (e.g., which may result in security breaches or the like). Thus, deployment of an updated codebase that is based on an outdated codebase may result in “change drift,” which may refer to code in development losing synchronization with code that is deployed in production.

Some implementations described herein enable the detection of a codebase associated with change drift prior to deployment of the codebase in a production environment. For example, a system may validate that the codebase is synchronized with current application code in the production environment before allowing deployment of the codebase. In some implementations, the system may track version identifiers (e.g., commit hashes) associated with codebases being deployed in order to detect a codebase associated with change drift. For example, prior to allowing deployment of a codebase that updates a previous codebase, the system may verify that a version identifier associated with the previous codebase matches a version identifier of a codebase most-recently successfully deployed to the production environment. If the version identifiers do not match, the system may cancel deployment of the codebase. In some implementations, the system may cause transmission of notifications (e.g., to developers associated with the codebase) indicating that deployment of the codebase was canceled due to change drift. If the version identifiers match, the system may cause deployment of the codebase to the production environment.

In this way, deployment to a production environment of a codebase associated with change drift can be avoided. Accordingly, a stability of application code in the production environment can be maintained, thereby maintaining critical features, bug fixes, security updates, or the like. Thus, systems implementing the production environment can operate efficiently, thereby conserving computing resources, and/or operate at needed security levels.

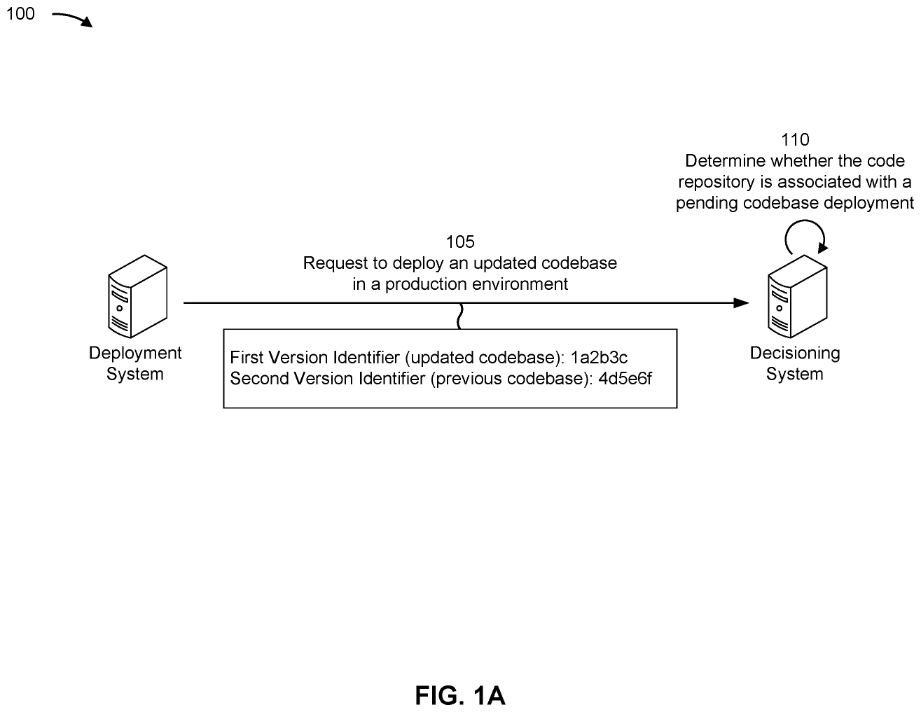

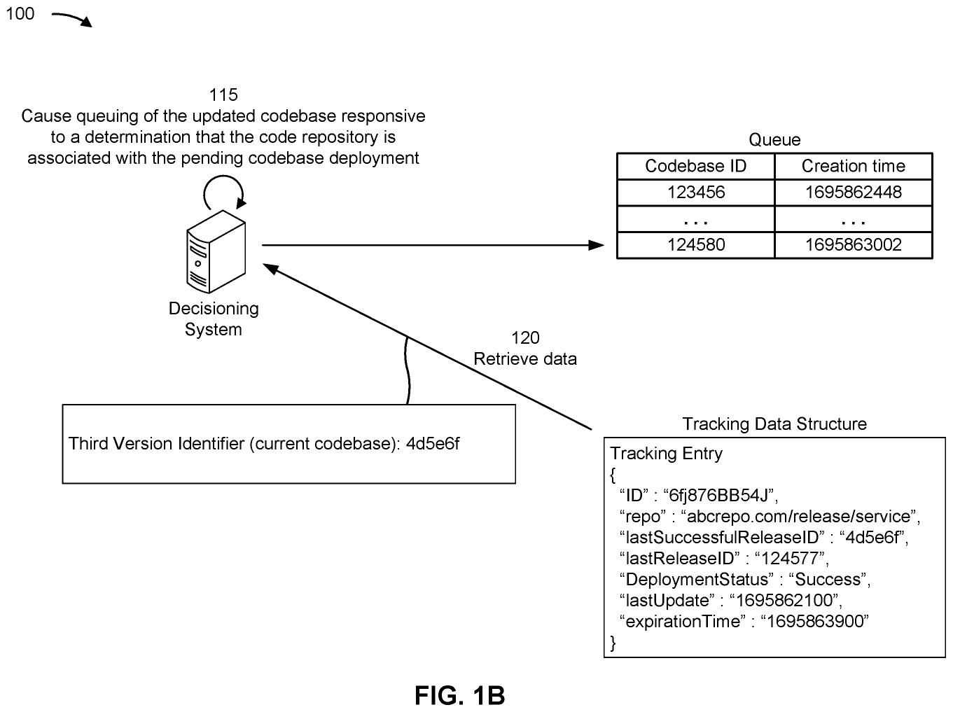

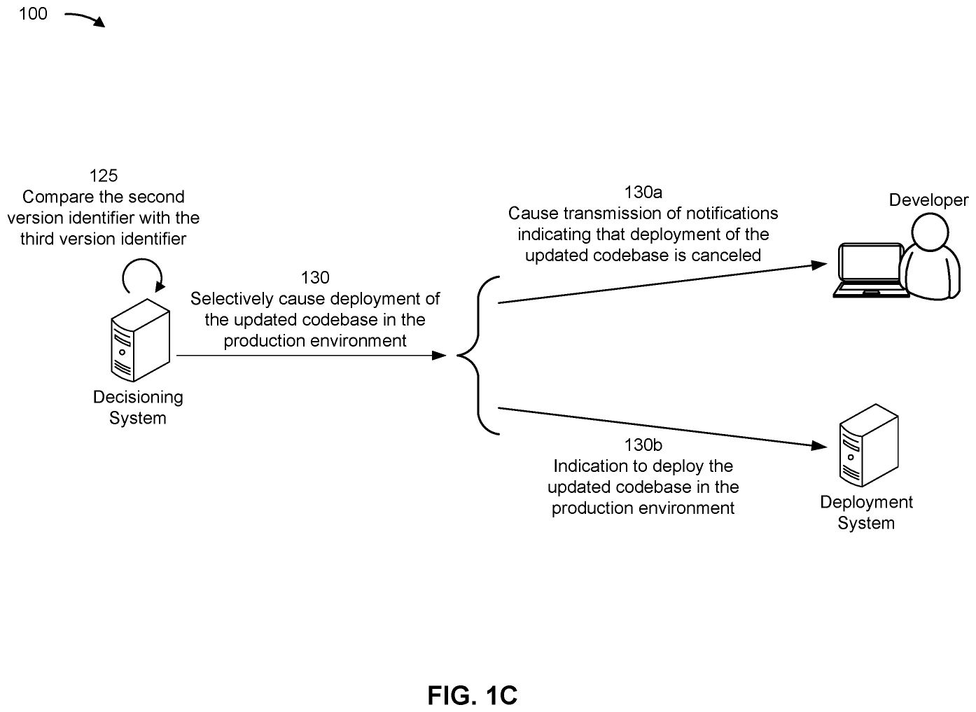

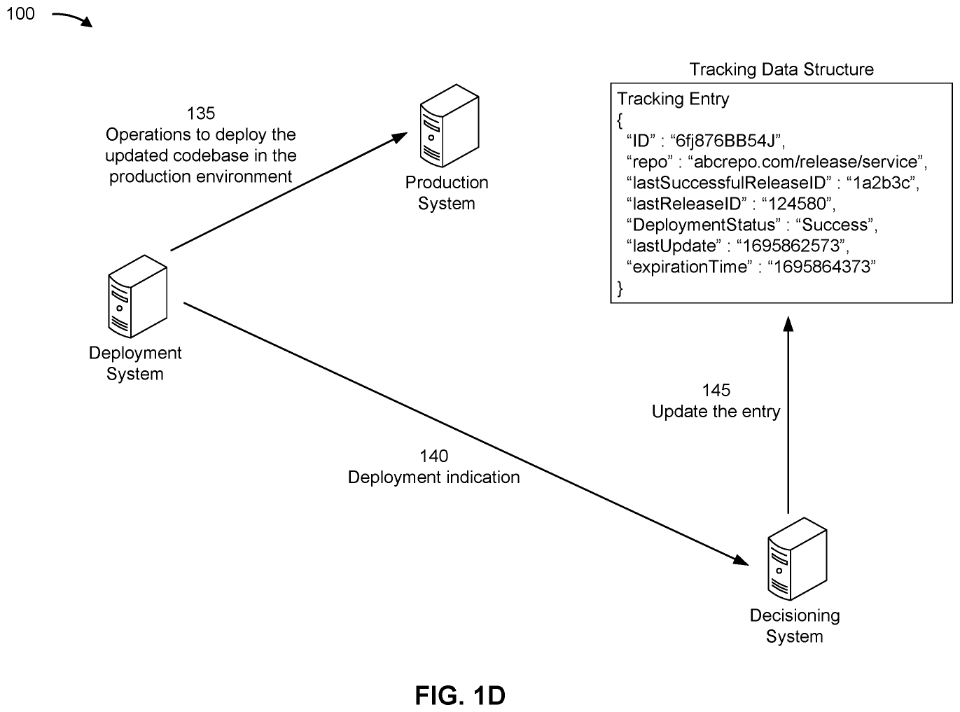

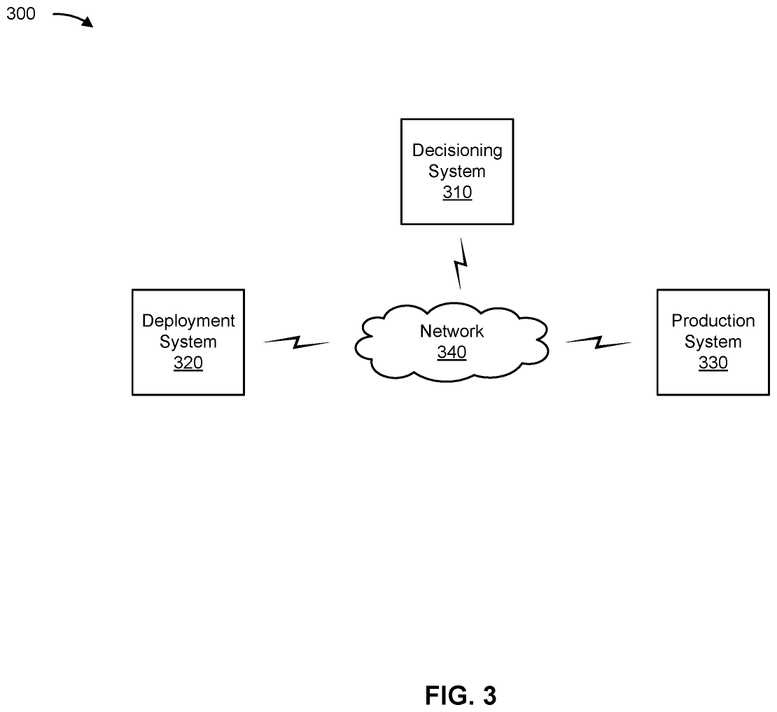

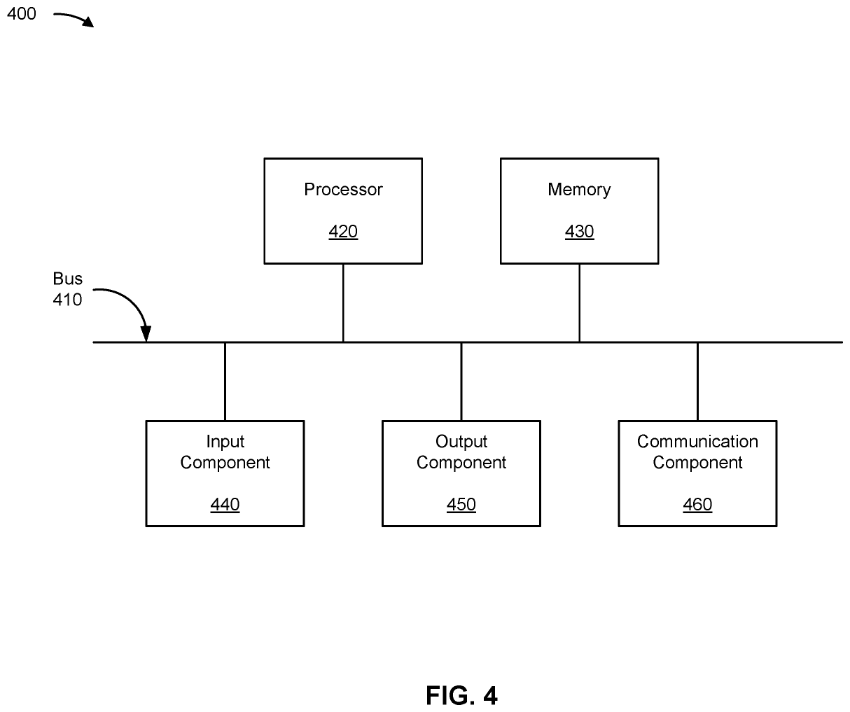

FIGS. 1A-1D are diagrams of an example 100 associated with maintaining synchronization of code for a production environment. As shown in FIGS. 1A-1D, example 100 includes a decisioning system, a deployment system, and a production system. These devices are described in more detail in connection with FIGS. 3 and 4.

The deployment system may implement a continuous integration and continuous delivery (CI/CD) pipeline. The deployment system may include, or may communicate with, one or more version control systems, one or more build automation systems, one or more testing systems, and/or one or more deployment automation systems. The production system may implement a production environment, where a current codebase (e.g., a code release) is deployed. In one example, the codebase may relate to a website. The decisioning system may perform operations relating to allowing or disallowing a codebase change (e.g., a release change) to be deployed by the deployment system in the production environment. For example, the decisioning system may validate various controls before allowing a codebase change to be deployed.

In some implementations, the decisioning system may implement a tracking data structure (e.g., a database, a table, a log, or the like) used to track codebase deployment. The tracking data structure may include one or more entries, and each entry may be particular to a respective code repository. An entry for a code repository may include a plurality of fields that indicate the code repository (e.g., identified using a uniform resource locator (URL) or the like), a version identifier for a codebase, of the code repository, that was most-recently successfully deployed to the production environment (which may be referred to herein as a “last successful release”), a unique identifier for a codebase, of the code repository, most-recently validated by the decisioning system (which may be referred to herein as a “last release”), a deployment status for the last release (which indicates, by extension, a deployment status of the code repository), and/or an expiration time for the last release.

As shown in FIG. 1A, and by reference number 105, the deployment system may transmit, and the decisioning system may receive, a request to deploy an updated codebase in the production environment. For example, the deployment system may transmit the request in response to generating the codebase and/or preparing the codebase for deployment. The updated codebase may be associated with (e.g., stored by) a code repository. The updated codebase may be based on a previous codebase of the code repository. For example, the previous codebase may be updated by the updated codebase. The previous codebase may have been previously deployed in the production environment (e.g., at least at a time when a branch for the updated codebase was created). Accordingly, the decisioning system may determine whether the previous codebase is the codebase that is currently deployed in the production environment before allowing the updated codebase to be deployed, as described herein.

The request may indicate a first version identifier associated with the updated codebase, and/or a second version identifier associated with the previous codebase. A version identifier may be an immutable and unique identifier that identifies a version (e.g., a most-recent version) of a codebase. For example, a version identifier may be a commit identifier. In some implementations, a version identifier may be a hash value (e.g., a secure hash algorithm (SHA) value). For example, the hash value may be based on the contents of a commit and/or metadata associated with the commit. In some implementations, the request may indicate the code repository associated with the updated codebase.

In some implementations, responsive to the request, the decisioning system may generate a record for the updated codebase. The record may signify that the updated codebase is awaiting deployment. For example, the record may signify that the updated codebase is undergoing a pre-deployment review. In some implementations, the record may indicate a unique identifier for the updated codebase, the code repository associated with the updated codebase (e.g., using a URL), and/or a creation time associated with the updated codebase.

In some implementations, responsive to the request, the decisioning system may determine whether the updated codebase is an initial codebase for the code repository. For example, the request lacking the second version identifier may indicate that the updated codebase is the initial codebase for the code repository (e.g., the updated codebase is actually new rather than an update). In some implementations, the decisioning system may determine whether the updated codebase is the initial codebase based on information in the tracking data structure. For example, an entry for the code repository (referred to herein as the “code repository entry”) being absent from the tracking data structure may indicate that the updated codebase is the initial codebase for the code repository. Responsive to a determination that the updated codebase is the initial codebase for the code repository, the decisioning system may allow deployment of the updated codebase, and the decisioning system may cause deployment of the updated codebase, as described herein. For example, change drift is not an issue for the initial codebase for the code repository, and therefore a change drift check, as described herein, is not needed. Otherwise (based on a determination that the updated codebase is not the initial codebase for the code repository), the decisioning system may perform a change drift check for the updated codebase, as described herein.

As shown by reference number 110, responsive to the request and a determination that the updated codebase is not the initial codebase for the code repository, the decisioning system may determine whether the code repository is associated with a pending (e.g., in-progress) codebase deployment in the production environment (e.g., whether a codebase of the code repository is in the process of being deployed to the production environment). For example, the decisioning system may identify whether the code repository entry indicates a pending deployment status for the code repository (e.g., for the last release). Responsive to a determination that the code repository is associated with the pending codebase deployment, the decisioning system may cause queuing of the updated codebase in a queue, as shown in FIG. 1B by reference number 115. For example, queueing of the updated codebase may cause the decisioning system to pause the change drift check for the updated codebase, and to monitor the deployment status associated with the code repository in the code repository entry. The decisioning system may release the updated codebase from the queue when the code repository is no longer associated with the pending codebase deployment. As an example, the decisioning system may un-pause the change drift check for the updated codebase responsive to the deployment status changing from a pending status to non-pending status, such as a success status or a failure status (or if an expiration time for a last release, indicated in the code repository entry, has expired).

As shown by reference number 120, responsive to the request and based on a determination that the code repository is not associated with the pending codebase deployment (e.g., there was no pending codebase deployment, or the updated codebase has been released from the queue upon the deployment status changing), the decisioning system may retrieve data from the code repository entry. For example, the data may include a third version identifier associated with a current codebase most-recently successfully deployed in the production environment (e.g., the version identifier in the last successful release field of the code repository entry).

As shown in FIG. 1C, and by reference number 125, the decisioning system may compare the second version identifier, associated with the previous codebase, with the third version identifier associated with the current codebase. The second version identifier matching the third version identifier may indicate that the previous codebase is the current codebase deployed in the production environment (e.g., the previous codebase and the current codebase are the same). For example, the second version identifier matching the third version identifier indicates an absence of change drift. In contrast, the second version identifier not matching the third version identifier may indicate that the previous codebase is different from the current codebase deployed in the production environment. For example, the second version identifier not matching the third version identifier indicates a presence of change drift.

As shown by reference number 130, the decisioning system may selectively cause deployment of the updated codebase in the production environment by the deployment system. In particular, the decisioning system may selectively cause deployment of the codebase in the production environment responsive to whether the second version identifier matches the third version identifier.

For example, responsive to the second version identifier not matching the third version identifier, the decisioning system may cancel deployment of the updated codebase. In some implementations, to cancel deployment of the updated codebase, the decisioning system may close the record for the updated codebase (e.g., delete the record, update the record to indicate a closed status, or the like). As an example, as shown by reference number 130a, responsive to the second version identifier not matching the third version identifier (e.g., in connection with canceling deployment of the updated codebase), the decisioning system may cause transmission of one or more notifications indicating that deployment of the updated codebase is canceled. For example, the notification(s) may indicate that change drift was detected in connection with the updated codebase. The notification(s) may be for one or more developers associated with the updated codebase, one or more development supervisors associated with the updated codebase, or the like. In some implementations, a notification may be provided to the deployment system.

In some implementations, responsive to the second version identifier not matching the third version identifier (e.g., in connection with canceling deployment of the updated codebase), the decisioning system may automatically cause, in connection with the code repository, a merging of a main branch into an update branch associated with the updates of the updated codebase and/or cause a rebasing of the update branch onto the main branch. In some implementations, responsive to the second version identifier not matching the third version identifier (e.g., in connection with canceling deployment of the updated codebase), the decisioning system may compare the updated codebase to the current codebase deployed in the production environment, may identify, based on the comparison, code present in the current codebase that is missing from the updated codebase, and may update the updated codebase to include the missing code.

Responsive to the second version identifier matching the third version identifier, the decisioning system may allow deployment of the updated codebase. For example, responsive to the second version identifier matching the third version identifier (and responsive to a determination that the code repository is not associated with the pending codebase deployment), the decisioning system may cause deployment of the updated codebase. In some implementations, responsive to allowing deployment of the updated codebase, the decisioning system may update the deployment status associated with the code repository in the entry of the tracking data structure to a pending status. As shown by reference number 130b, responsive to the second version identifier matching the third version identifier (e.g., in connection with allowing deployment of the updated codebase), the decisioning system may transmit, and the deployment system may receive, an indication to deploy the updated codebase in the production environment. As shown in FIG. 1D, and by reference number 135, responsive to the indication, the deployment system may perform one or more operations to deploy the updated codebase in the production environment.

In some implementations, after allowing deployment of the updated codebase, the decisioning system may receive one or more requests to deploy additional codebases associated with the same code repository as the updated codebase. Here, the decisioning system (e.g., responsive to a determination that the code repository is associated with a pending status in connection with deployment of the updated codebase) may queue the additional codebase(s), in a similar manner as described above, while deployment of the updated codebase is in progress. Accordingly, the queued additional codebase(s) may then proceed with a change drift check after deployment of the updated codebase is completed, as described below. A queue order (e.g., an order in which codebases are released from the queue) may be in accordance with a creation time associated with a codebase.

As shown by reference number 140, the deployment system may transmit, and the decisioning system may receive, a deployment indication. The deployment indication may indicate whether deployment of the updated codebase in the production environment succeeded or failed. For example, the deployment indication may include a status code associated with deployment of the updated codebase in the production environment. In some implementations, the decisioning system may update the deployment status for the code repository in the entry of the tracking data structure in accordance with the deployment indication. In some implementations, the decisioning system may update the record for the updated codebase to indicate that deployment of the updated codebase in the production environment (e.g., whether successful or not) is complete. For example, the decisioning system may update the record to indicate the status code of the deployment indication.

As shown by reference number 145, responsive to the deployment indication indicating that deployment of the updated codebase succeeded, the decisioning system may update the entry in the tracking data structure (e.g., update the last successful release field in the entry) to replace the third version identifier with the first version identifier, thereby indicating that the most-recent successfully deployed codebase is now the updated codebase.

By tracking the version identifier of the most-recent successfully deployed codebase and performing a change drift check using that version identifer, as described herein, change drift can be detected before a codebase is deployed to the production environment. Accordingly, a stability of application code in the production environment can be maintained, thereby maintaining critical features, bug fixes, security updates, or the like. Thus, the production environment system can operate efficiently, thereby conserving computing resources, and/or can operate at needed security levels.

As indicated above, FIGS. 1A-1D are provided as an example. Other examples may differ from what is described with regard to FIGS. 1A-1D.

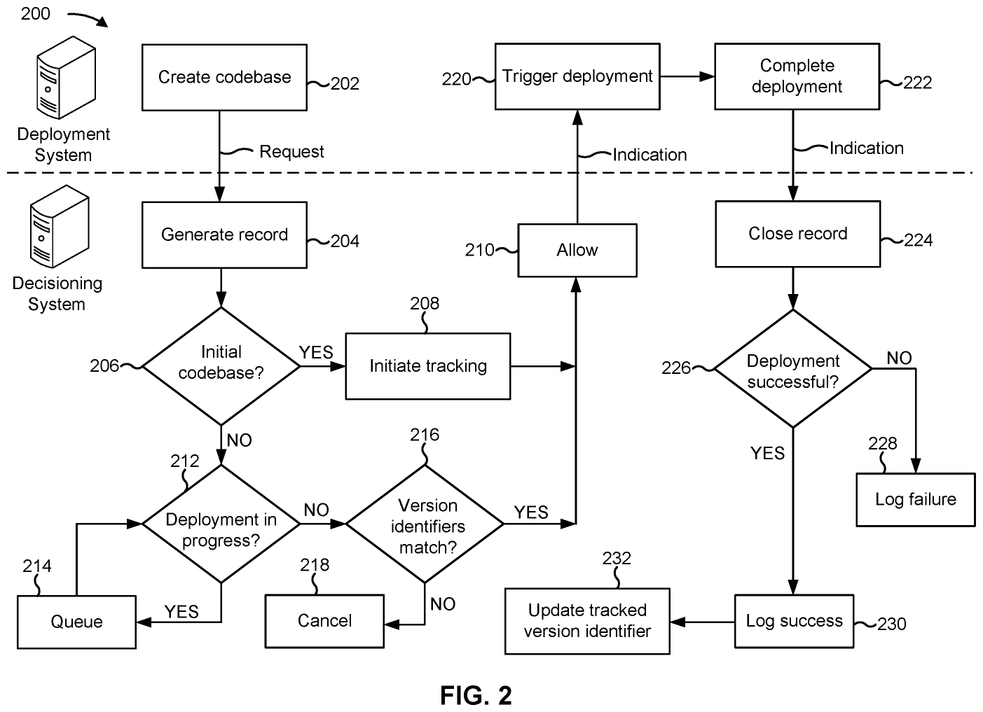

FIG. 2 is a flowchart of an example process 200 associated with maintaining synchronization of code for a production environment.

As shown, in process 200, the deployment system may create a codebase (block 202). For example, creating the codebase may include generating the codebase and/or preparing the codebase for deployment. In connection with creating the codebase, the deployment system may transmit a request, to the decisioning system, to deploy the codebase, as described herein. For example, the request may indicate a first version identifier associated with the codebase and a second version identifier associated with a previous codebase that the codebase modifies.

In process 200, the decisioning system may generate a record (block 204), as described herein. In process 200, the decisioning system may determine whether the codebase is an initial codebase for a code repository (block 206), as described herein. Based on a determination that the codebase is the initial codebase (block 206—YES), the decisioning system may initiate tracking for the codebase (block 208). For example, initiating tracking for the codebase may include populating one or more fields of an entry for the code repository, in a tracking data structure, with information relating to the codebase, as described herein. In process 200, based on the codebase being an initial codebase for the code repository, the decisioning system may allow deployment of the codebase (block 210), as described herein.

Based on a determination that the codebase is not the initial codebase (block 206—NO), in process 200, the decisioning system may determine whether a deployment of a different codebase of the code repository is in progress (block 212), as described herein. For example, the entry may indicate a deployment status associated with the code repository. Based on a determination that there is a deployment in progress (block 212—YES), in process 200, the decisioning system may queue the codebase (block 214), as described herein. For example, the codebase may be queued until deployment of the different codebase has completed (e.g., either successfully or in failure). As an example, the decisioning system may monitor the deployment status in the entry to detect that deployment of the different codebase has completed.

Based on a determination that there is not a deployment in progress (block 212—NO), in process 200, the decisioning system may determine whether the second version identifier, associated with the previous codebase modified by the codebase, matches a third version identifier associated with a most-recent codebase to be successfully deployed in the production environment (block 216), as described herein. For example, the decisioning system may obtain the third version identifier from the entry.

Based on a determination that the version identifiers do not match (block 216—NO), in process 200, the decisioning system may cancel deployment of the codebase (block 218), as described herein. The version identifiers not matching indicates change drift of the codebase. The decisioning system may close the record generated at block 204 to indicate that deployment of the codebase is canceled. Based on a determination that the version identifiers match (block 216—YES), in process 200, the decisioning system may allow deployment of the codebase (block 210), as described herein. The version identifiers matching indicates no change drift of the codebase (e.g., indicates that the codebase is based on the currently-deployed codebase in the production environment).

Based on allowing deployment of the codebase, the decisioning system may transmit an indication to the deployment system to cause deployment of the codebase. In process 200, based on receiving the indication, the deployment system may trigger deployment of the codebase (block 220). For example, the deployment system may cause the codebase to be installed in one or more devices of the production environment. In process 200, the deployment system may complete deployment of the codebase (block 222). For example, the deployment system may perform a deployment clean-up operation, may perform testing and/or checks on the deployment, may generate a deployment status code relating to the deployment, or the like.

The deployment system may transmit, to the decisioning system, an indication of the deployment status code, as described herein. For example, the deployment status code may indicate whether the deployment succeeded or failed. In process 200, based on receiving the indication, the decisioning system may close the record generated at block 204 (block 224). For example, the decisioning system may update the record with the deployment status code. In process 200, the decisioning system may determine whether the deployment was successful (block 226). For example, the decisioning system may determine whether the deployment was successful based on the deployment status code.

Based on a determination that the deployment was not successful (block 226—NO), in process 200, the decisioning system may log the failure of the deployment (block 228), as described herein. For example, the decisioning system may update the deployment status of the entry to indicate a failure status. Based on a determination that the deployment was successful (block 226—YES), in process 200, the decisioning system may log the success of the deployment (block 230), as described herein. For example, the decisioning system may update the deployment status of the entry to indicate a success status. Further based on a determination that the deployment was successful, in process 200, the decisioning system may update the version identifier being tracked in the entry (block 232), as described herein. For example, the version identifier being tracked may be updated from the third version identifier to the first version identifier associated with the codebase (e.g., because the codebase is now the most-recent codebase to be successfully deployed in the production environment).

Process 200 may be repeated for each codebase that is to be deployed in the production environment. In this way, each codebase can be checked for change drift before deployment in the production environment.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel. The process 200 is an example of one process that may be performed by one or more devices described herein. These one or more devices may perform one or more other processes based on operations described herein, such as the operations described in connection with FIGS. 1A-1D. Moreover, while the process 200 has been described in relation to the devices and components of the preceding figures, the process 200 can be performed using alternative, additional, or fewer devices and/or components. Thus, the process 200 is not limited to being performed with the example devices, components, hardware, and software explicitly enumerated in the preceding figures.

FIG. 3 is a diagram of an example environment 300 in which systems and/or methods described herein may be implemented. As shown in FIG. 3, environment 300 may include a decisioning system 310, a deployment system 320, a production system 330, and a network 340. Devices of environment 300 may interconnect via wired connections, wireless connections, or a combination of wired and wireless connections.

The decisioning system 310 may include one or more devices capable of receiving, generating, storing, processing, providing, and/or routing information associated with maintaining synchronization of code for a production environment, as described elsewhere herein. The decisioning system 310 may include a communication device and/or a computing device. For example, the decisioning system 310 may include a server, such as an application server, a client server, a web server, a database server, a host server, a proxy server, a virtual server (e.g., executing on computing hardware), or a server in a cloud computing system. In some implementations, the decisioning system 310 may include computing hardware used in a cloud computing environment.

The deployment system 320 may include one or more devices capable of receiving, generating, storing, processing, providing, and/or routing information associated with maintaining synchronization of code for a production environment, as described elsewhere herein. The deployment system 320 may include a communication device and/or a computing device. For example, the deployment system 320 may include a server, such as an application server, a client server, a web server, a database server, a host server, a proxy server, a virtual server (e.g., executing on computing hardware), or a server in a cloud computing system. In some implementations, the deployment system 320 may include computing hardware used in a cloud computing environment.

The production system 330 may include one or more devices capable of receiving, generating, storing, processing, providing, and/or routing information associated with a production environment, as described elsewhere herein. The production system 330 may include a communication device and/or a computing device. For example, the production system 330 may include a server, such as an application server, a client server, a web server, a database server, a host server, a proxy server, a virtual server (e.g., executing on computing hardware), or a server in a cloud computing system. In some implementations, the production system 330 may include computing hardware used in a cloud computing environment.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with maintaining synchronization of code for a production environment. The device 400 may correspond to decisioning system 310, deployment system 320, and/or production system 330. In some implementations, decisioning system 310, deployment system 320, and/or production system 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420.

The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

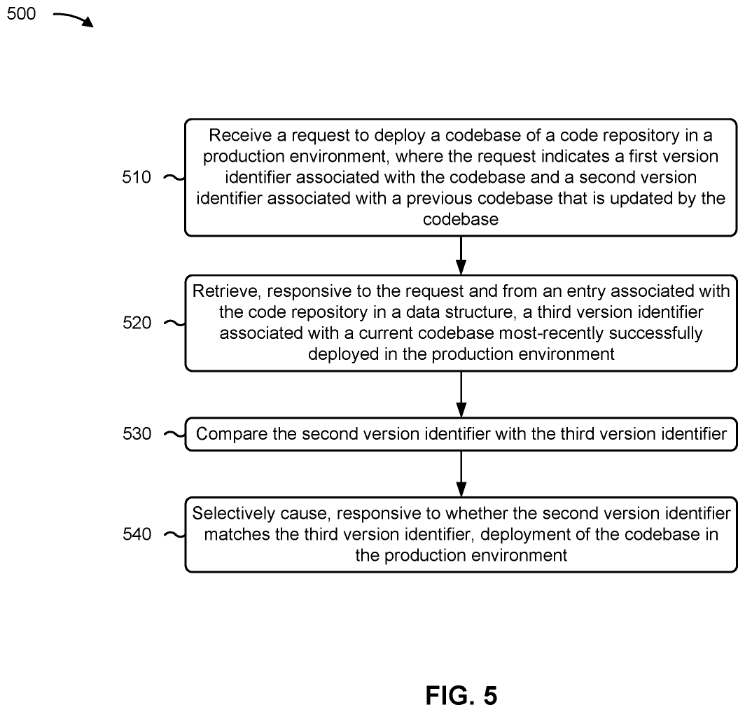

FIG. 5 is a flowchart of an example process 500 associated with maintaining synchronization of code for a production environment. In some implementations, one or more process blocks of FIG. 5 may be performed by the decisioning system 310. In some implementations, one or more process blocks of FIG. 5 may be performed by another device or a group of devices separate from or including the decisioning system 310, such as the deployment system 320 and/or the production system 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving a request to deploy a codebase of a code repository in a production environment, where the request indicates a first version identifier associated with the codebase and a second version identifier associated with a previous codebase that is updated by the codebase (block 510). For example, the decisioning system 310 (e.g., using processor 420, memory 430, and/or communication component 460) may receive a request to deploy a codebase of a code repository in a production environment, as described above in connection with reference number 105 of FIG. 1A. As an example, the request may be received from a deployment system in response to the deployment system generating the codebase and/or preparing the codebase for deployment.

As further shown in FIG. 5, process 500 may include retrieving, responsive to the request and from an entry associated with the code repository in a data structure, a third version identifier associated with a current codebase most-recently successfully deployed in the production environment (block 520). For example, the decisioning system 310 (e.g., using processor 420 and/or memory 430) may retrieve, responsive to the request and from an entry associated with the code repository in a data structure, a third version identifier associated with a current codebase most-recently successfully deployed in the production environment, as described above in connection with reference number 120 of FIG. 1B. As an example, the third version identifier may be retrieved based on a determination that the code repository is not associated with a pending codebase deployment.

As further shown in FIG. 5, process 500 may include comparing the second version identifier with the third version identifier (block 530). For example, the decisioning system 310 (e.g., using processor 420 and/or memory 430) may compare the second version identifier with the third version identifier, as described above in connection with reference number 125 of FIG. 1C. As an example, the second version identifier matching the third version identifier indicates that the previous codebase is the current codebase most-recently successfully deployed in the production environment.

As further shown in FIG. 5, process 500 may include selectively causing, responsive to whether the second version identifier matches the third version identifier, deployment of the codebase in the production environment by the deployment system (block 540). For example, the decisioning system 310 (e.g., using processor 420, memory 430, and/or communication component 460) may selectively cause, responsive to whether the second version identifier matches the third version identifier, deployment of the codebase in the production environment by the deployment system, as described above in connection with reference number 130 of FIG. 1C. As an example, responsive to the second version identifier not matching the third version identifier, deployment of the codebase may be canceled, whereas responsive to the second version identifier matching the third version identifier, deployment of the codebase may be allowed.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for maintaining synchronization of code for a production environment, the system comprising:
one or more memories; and
one or more processors, communicatively coupled to the one or more memories, configured to:
receive, from a deployment system, a request to deploy a codebase of a code repository in a production environment,
wherein the request indicates a first version identifier associated with the codebase and a second version identifier associated with a previous codebase that is updated by the codebase;
retrieve, responsive to the request and from an entry associated with the code repository in a data structure, a third version identifier associated with a current codebase most-recently successfully deployed in the production environment;
compare the second version identifier with the third version identifier,
wherein the second version identifier matching the third version identifier indicates that the previous codebase is the current codebase most-recently successfully deployed in the production environment; and
selectively cause, responsive to whether the second version identifier matches the third version identifier, deployment of the codebase in the production environment by the deployment system.

2. The system of claim 1, wherein the one or more processors, to selectively cause deployment of the codebase, are configured to:
transmit, to the deployment system and responsive to the second version identifier matching the third version identifier, an indication to deploy the codebase in the production environment.

3. The system of claim 1, wherein the one or more processors are further configured to:
determine whether the codebase is an initial codebase for the code repository.

4. The system of claim 3, wherein the one or more processors are further configured to:
cause deployment of the codebase in the production environment responsive to a determination that the codebase is the initial codebase for the code repository.

5. The system of claim 3, wherein the one or more processors are further configured to:
determine, responsive to a determination that the codebase is not the initial codebase for the code repository, whether the code repository is associated with a pending codebase deployment in the production environment.

6. The system of claim 5, wherein the one or more processors, to selectively cause deployment of the codebase, are configured to:
cause deployment of the codebase in the production environment responsive to a determination that the code repository is not associated with the pending codebase deployment.

7. The system of claim 5, wherein the one or more processors are further configured to:
queue the codebase in a queue responsive to a determination that the code repository is associated with the pending codebase deployment.

8. The system of claim 1, wherein the one or more processors are further configured to:
cause, responsive to the second version identifier not matching the third version identifier, transmission of one or more notifications indicating that deployment of the codebase is canceled.

9. The system of claim 1, wherein the one or more processors, to selectively cause deployment of the codebase, are configured to:
cause deployment of the codebase in the production environment responsive to the second version identifier matching the third version identifier.

10. The system of claim 1, wherein the first version identifier, the second version identifier, and the third version identifier are commit hashes.

11. A method of maintaining synchronization of code for a production environment, comprising:
receiving a request to deploy a codebase of a code repository in a production environment,
wherein the request indicates a first version identifier associated with the codebase and a second version identifier associated with a previous codebase that is updated by the codebase;
retrieving, from an entry associated with the code repository in a data structure, a third version identifier associated with a current codebase most-recently successfully deployed in the production environment;
comparing the second version identifier with the third version identifier,
wherein the second version identifier matching the third version identifier indicates that the previous codebase is the current codebase most-recently successfully deployed in the production environment; and
causing, responsive to the second version identifier matching the third version identifier, deployment of the codebase in the production environment.

12. The method of claim 11, wherein causing deployment of the codebase comprises:
transmitting, to a deployment system, an indication to deploy the codebase in the production environment.

13. The method of claim 11, further comprising:
receiving an indication of whether deployment of the codebase in the production environment succeeded or failed; and
updating, responsive to the indication indicating that deployment succeeded, the entry in the data structure to replace the third version identifier with the first version identifier.

14. The method of claim 11, further comprising:
determining whether the codebase is an initial codebase for the code repository;
determining, responsive to a determination that the codebase is not the initial codebase for the code repository, whether the code repository is associated with a pending codebase deployment in the production environment;
queueing the codebase in a queue responsive to a determination that the code repository is associated with the pending codebase deployment; and
releasing the codebase from the queue when the code repository is no longer associated with the pending codebase deployment.

15. The method of claim 11, wherein the entry in the data structure indicates:
the code repository,
the third version identifier, and
a deployment status for the code repository.

16. A non-transitory computer-readable medium storing a set of instructions for maintaining synchronization of code for a production environment, the set of instructions comprising:
one or more instructions that, when executed by one or more processors of a device, cause the device to:
receive, from a deployment system, a request to deploy a codebase of a code repository in a production environment,
wherein the request indicates a first commit hash associated with the codebase and a second commit hash associated with a previous codebase that is updated by the codebase;
retrieve, responsive to the request and from a data structure, a third commit hash associated with a current codebase most-recently successfully deployed in the production environment;
compare the second commit hash with the third commit hash,
wherein the second commit hash matching the third commit hash indicates that the previous codebase is the current codebase most-recently successfully deployed in the production environment; and
cause, responsive to the second commit hash matching the third commit hash, deployment of the codebase in the production environment.

17. The non-transitory computer-readable medium of claim 16, wherein the one or more instructions, that cause the device to cause deployment of the codebase, cause the device to:
transmit, to a deployment system, an indication to deploy the codebase in the production environment.

18. The non-transitory computer-readable medium of claim 16, wherein the one or more instructions, when executed by the one or more processors, further cause the device to:
generate, responsive to the request, a record for the codebase signifying that the codebase is awaiting deployment.

19. The non-transitory computer-readable medium of claim 16, wherein the one or more instructions, when executed by the one or more processors, further cause the device to:
determine whether the codebase is an initial codebase for the code repository;
determine, responsive to a determination that the codebase is not the initial codebase for the code repository, whether the code repository is associated with a pending codebase deployment in the production environment; and
queue the codebase in a queue responsive to a determination that the code repository is associated with the pending codebase deployment.

20. The non-transitory computer-readable medium of claim 19, wherein the one or more instructions, when executed by the one or more processors, further cause the device to:
monitor, in a data structure, a deployment status associated with the code repository; and
release the codebase from the queue responsive to the deployment status changing from a pending status to a non-pending status.
